(19) United States
(12) Patent Application Publication
(10) Pub. No.: US 2022/0083494 A1
(43) Pub. Date: Mar. 17, 2022

(54) METHOD FOR PROVIDING SHARED DATA ON BASIS OF DEVICE ATTRIBUTE AND ELECTRONIC DEVICE FOR SAME

(71) Applicant: SAMSUNG ELECTRONICS CO., LTD., Suwon-si, Gyeonggi-do (KR)

(72) Inventor: Bokun CHOI, Suwon-si, Gyeonggi-do (KR)

(21) Appl. No.: 17/422,304

(22) PCT Filed: Jan. 16, 2020
(86) PCT No.: PCT/KR2020/000778

§ 371 Date: Jul. 12, 2021

(30) Foreign Application Priority Data
Jan. 16, 2019 (KR) 10-2019-0005809

(51) Int. Cl. G06F 15/167; G06F 16/27; G06F 16/953; G06F 16/2457

(52) U.S. Cl. CPC G06F 15/167; G06F 16/24573; G06F 16/953; G06F 16/27

(57) ABSTRACT

Disclosed is an electronic device comprising: a display; a communication circuit; a processor coupled to the display and the communication circuit; and a memory operatively coupled to the processor. The memory may store instructions that, when executed, cause the processor to: receive, by using the communication circuit, shared data from an external server device and metadata generated by means of the external server device; reconstruct at least a portion of the shared data on the basis of a device attribute set on the basis of at least a portion of the metadata and uses of the electronic device; and display the reconstructed at least a portion of the shared data on the display. Various other embodiments which can be known from the specification are also possible.

### TECHNICAL FIELD

Various embodiments of the present disclosure relate to a method for providing shared data based on a device attribute and an electronic device therefor.

### BACKGROUND ART

Since the types and number of electronic devices that support an Internet connection increase, various electronic devices may be managed in a user-oriented manner. For example, a plurality of electronic devices may be associated with a single user account, and a user may integrally manage the plurality of electronic devices through the user account. Data may be shared between the plurality of electronic devices to provide an integrated use environment to the user. For example, favorite web page information configured by the user may be shared between the plurality of electronic devices. The user may easily access the same web page using any electronic device among the plurality of electronic devices and the shared favorite web page information.

### DISCLOSURE OF THE INVENTION

### Technical Problem

When a first electronic device and a second electronic device share data, the second electronic device may receive shared data transmitted from the first electronic device. For example, when the second electronic device receives a list of favorites as shared data, the second electronic device may provide the list of favorites to a user in a manner similar to that of the first electronic device.

In the case where the first electronic device and the second electronic device are different types of electronic devices, providing shared data in the same manner may deteriorate user experience. For example, in the case where the first electronic device is a desktop computer and the second electronic device is a television, use types and/or capabilities of the first electronic device and the second electronic device may be different from each other. Therefore, if the second electronic device provides shared data in the same manner as that of the first electronic device, the shared data may be provided to the user in a manner that does not correspond to the use type and/or capability of the second electronic device. Furthermore, user's needs for the first electronic device and the second electronic device may be different from each other. Therefore, if the second electronic device provides shared data in the same manner as that of the first electronic device, the shared data may be provided to the user in a manner that does not meet the user's needs for the second electronic device.

Various embodiments of the present disclosure may provide an electronic device supporting a data sharing method that is based on a device attribute.

### Technical Solution

An electronic device according to an embodiment of the present disclosure may include a display, a communication circuit, a processor operatively connected to the display and the communication circuit, and a memory operatively connected to the processor, wherein the memory may store instructions that, when executed, cause the processor to: receive, from an external server device, shared data and meta data generated by the external server device using the communication circuit; reconfigure at least a portion of the shared data based on a device attribute that is set at least partially based on the received meta data and a use of the electronic device; and display at least a portion of the reconfigured shared data on the display.

A shared data providing method of an electronic device according to an embodiment of the present disclosure may include: receiving, from an external server device, shared data and meta data generated by the external server device; reconfiguring at least a portion of the shared data based on a device attribute that is set at least partially based on the received meta data and a use of an external electronic device connected to the electronic device; and displaying at least a portion of the reconfigured shared data on a display of the external electronic device.

A data sharing system according to an embodiment of the present disclosure may include: a first electronic device configured to transmit shared data to an external server device; the external server device configured to classify the shared data received from the first electronic device based on a plurality of device attributes, generate meta data including classification information about the shared data, and transmit the meta data and the shared data to a second electronic device associated with the first electronic device; and the second electronic device configured to receive the shared data and the meta data from the external server device, reconfigure at least a portion of the shared data based on a device attribute of the second electronic device and the meta data, and provide at least a portion of the reconfigured shared data.

### Advantageous Effects

According to various embodiments of the present disclosure, shared data may be provided to a user in correspondence to the type of an electronic device by providing the shared data based on a device attribute.

According to various embodiments of the present disclosure, shared data may be provided to a user so as to meet the intent of the user by classifying and/or reconfiguring the shared data based on a device attribute.

Besides, various effects may be provided that are directly or indirectly identified through the present disclosure.

### BRIEF DESCRIPTION OF THE DRAWINGS

FIG. 1 is a block diagram illustrating an electronic device in a network environment according to various embodiments.

FIG. 2 illustrates a data sharing system according to various embodiments.

FIG. 3 illustrates an example configuration of a data sharing system according to an embodiment.

FIG. 4 is a signal flowchart illustrating a shared information providing method according to various embodiments.

FIG. 5 illustrates a first UI according to an embodiment.

FIG. 6 illustrates a second UI according to an embodiment.

FIG. 7 illustrates a third UI according to an embodiment.

FIG. 8 illustrates a configuration of shared information according to various embodiments.

FIG. 9 is a signal flowchart illustrating a method for providing shared information and additional information according to various embodiments.

FIG. 10 illustrates a fourth UI according to an embodiment.

FIG. 11 illustrates a fifth UI according to an embodiment.

FIG. 12 illustrates a second electronic device in a shared data output environment according to an embodiment.

FIG. 13 illustrates a data sharing environment according to an embodiment.

FIG. 14 is a flowchart illustrating a data providing method according to various embodiments.

FIG. 15 is a flowchart illustrating an additional information providing method according to various embodiments.

With respect to the description of the drawings, the same or similar reference signs may be used for the same or similar elements.

### MODE FOR CARRYING OUT THE INVENTION

Hereinafter, various embodiments of the present disclosure will be described with reference to the accompanying drawings. It should be understood that the embodiments and the terms used herein are not intended to limit the technology described in the present disclosure to specific embodiments, but rather include various modifications, equivalents and/or alternatives of the embodiments.

[symbol]

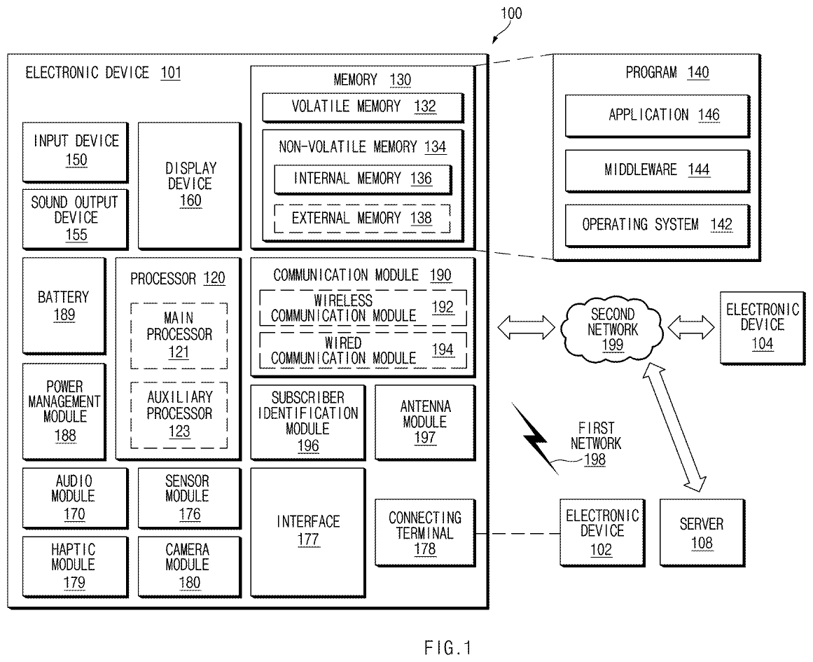

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

[symbol]

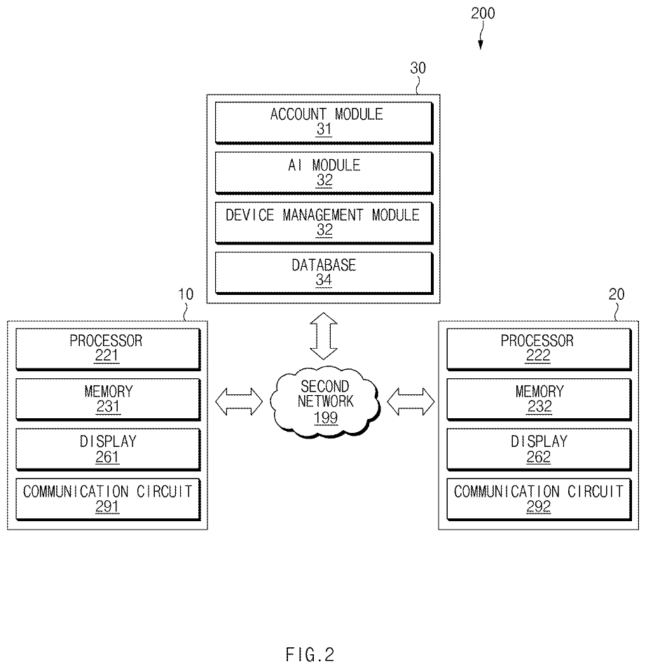

FIG. 2 illustrates a data sharing system 200 according to various embodiments.

According to various embodiments, the data sharing system 200 may include a first electronic device 10, a second electronic device 20, and a server 30. The first electronic device 10, the second electronic device 20, and/or the server 30 may communicate with each other via a second network 199 (e.g., Internet). The configuration of the data sharing system 200 illustrated in FIG. 2 is illustrative, and embodiments of the present disclosure are not limited thereto. For example, although FIG. 2 illustrates only the first electronic device 10 and the second electronic device 20, data may be shared between two or more electronic devices.

According to various embodiments, each of the first electronic device 10 and the second electronic device 20 may have a structure similar to that of the electronic device 101 of FIG. 1. According to an embodiment, the first electronic device 10 may include a processor 221 (e.g., the processor 120 of FIG. 1), a memory 231 (e.g., the memory 130 of FIG. 1), a display 261 (e.g., the display device 160 of FIG. 1), and a communication circuit 291 (e.g., the communication module 190 of FIG. 1). According to an embodiment, the second electronic device 20 may include a processor 222 (e.g., the processor 120 of FIG. 1), a memory 232 (e.g., the memory 130 of FIG. 1), a display 262 (e.g., the display device 160 of FIG. 1), and a communication circuit 292 (e.g., the communication module 190 of FIG. 1). According to an embodiment, each of the first electronic device 10 and the second electronic device 20 may be an electronic device capable of accessing the Internet. For example, each of the second electronic device 10 and the second electronic device 20 may be a wearable device, personal computer (PC), TV, refrigerator, washing machine, smartphone, or vehicular electronic device capable of accessing the Internet.

According to various embodiments, the server 30 may include an account module 31, an AI module 32, a device management module 33, and a database 34. According to an embodiment, at least two of the account module 31, the AI module 32, the device management module 33, and the database 34 may be formed as a single module. According to an embodiment, the server device 30 may be configured with one or more servers. At least one of the account module 31, the AI module 32, the device management module 33, and the database 34 may be located in at least one separate server.

According to an embodiment, the account module 31 may store and manage information (e.g., identification information, phone number, name, e-mail, contact, and/or password) about a plurality of accounts. According to an embodiment, the AI module 32 may classify data using AI such as machine learning. The AI module 32 may extract at least one keyword from data. According to an embodiment, the device management module 33 may store and manage information (e.g., identifiers of electronic devices, model names of electronic devices, device attribute information about electronic device, and/or account information associated with electronic devices) about a plurality of electronic devices. For example, the device management module 33 may store information indicating that the first electronic device 10 and the second electronic device 20 are electronic devices associated with the same account. According to an embodiment, the database 34 may store shared data, meta data, and/or additional data.

According to various embodiments, the first electronic device 10 and the second electronic device 20 may share data. For example, data shared between the first electronic device 10 and the second electronic device 20 may be referred to as shared data. According to an embodiment, the first electronic device 10 and the second electronic device may share shared data via the server 30. For example, the first electronic device 10 may transmit the shared data to the server 30, and the second electronic device 20 may receive the shared data from the server 30. According to an embodiment, the first electronic device 10 and the second electronic device 20 may be electronic devices associated with the same account. For example, the first electronic device 10 and the second electronic device 20 may be electronic devices associated with the same account stored in the server 30. The data sharing system 200 may construct an integrated user environment in electronic devices of the data sharing system (e.g., electronic devices associated with an account of the data sharing system) by allowing data sharing between electronic devices associated with the same account.

According to various embodiments, the shared data may be data associated with web content. For example, the shared data may include at least one web page address associated with web content. For example, the shared data may include “read later”, “bookmark”, “screen capture”, “note writing”, or “clipped” web page information. For another example, the shared data may be multimedia data (e.g., pictures (e.g., an image created by a user, an image captured by a user, or an image stored by a user) and/or videos (e.g., a web video selected by a user so as to be shared and/or a video shot by a user). For another example, the shared data may be information (e.g., life logging, exercise data, and/or health data) collected by an electronic device (e.g., the first electronic device 10). For another example, the shared data may be content configured by an application of an electronic device or content configured by a service provider.

[symbol]

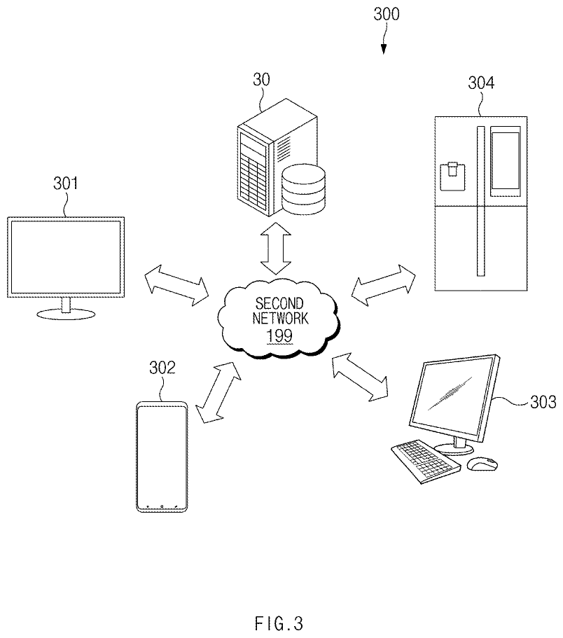

FIG. 3 illustrates an example configuration of the data sharing system 200 according to an embodiment.

In FIG. 3, the data sharing system 200 may include a plurality of electronic devices 301, 302, 303, and 304 and the server 30. For example, the plurality of electronic devices 301, 302, 303, and 304 may be electronic devices associated with an account of the same server 30. Each of the plurality of electronic devices 301, 302, 303, and 304 may correspond to the first electronic device 10 or the second electronic device 20 of FIG. 2.

According to an embodiment, the data sharing system 200 may include a TV 301, a smartphone 302, a PC 303, and a refrigerator 304. For example, shared data collected by the PC 303 may be shared with the smartphone 302 via the server 30. In this case, the user may desire to use, in the smartphone 302, shared data (e.g., bookmark) that the user used in the PC 303. When the user uses the PC 303 or the smartphone 302, the user may use shared data for simple web surfing. For another example, shared data collected by the PC 303 may be shared with the TV 301 or the refrigerator 304 via the server 30. In this case, the user's purpose of using the shared data in the TV 301 or the refrigerator 304 may be different from that of using it in the PC 303 or the smartphone 302. For example, since the TV 301 is used mainly to view multimedia, the user's purpose of using the shared data in the TV 301 may be to access information associated with multimedia among pieces of the shared data. For another example, since the refrigerator 304 is used mainly to store food, the user's purpose of using the shared data in the refrigerator 304 may be to access information associated with food or cooking. The user may use the same shared data for different purposes according to devices for accessing the shared data. For example, the user's intent may be determined according to a device in which the shared data of the user is used. Therefore, in order to provide shared data that meets the user's intent, an electronic device that has received shared data may provide the shared data to the user based on a device attribute.

According to various embodiments, the device attribute may be classified according to a use of an electronic device. The use of an electronic device may refer to a general use of the electronic device. For example, multipurpose devices such as the PC 303 and the smartphone 302 may have the same use. For another example, the use of the TV 301 may be to play multimedia. For another example, the use of the refrigerator 304 may be to store food or maintain a fixed temperature. According to an embodiment, the device attribute may be further classified based on a capability of an electronic device. For example, the capability of an electronic device may be classified based on a display type (e.g., ratio, size, resolution, and/or touch screen), input means (e.g., touch screen, keyboard, and/or voice recognition), and/or mobility (e.g., mobile device or fixed device) of the electronic device.

As described above, since the device attribute of an electronic device may vary according to the electronic device, the electronic device may provide shared data based on the device attribute in order to provide the shared data that meets the user's intent. The data sharing system 200 may provide shared data according to the methods described below. The above descriptions may be applied to the following descriptions, unless otherwise described.

[symbol]

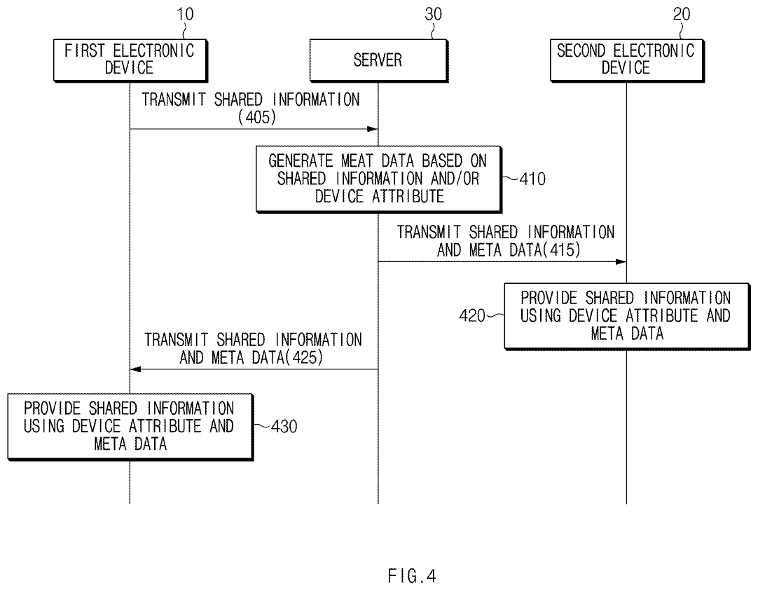

FIG. 4 is a signal flowchart illustrating a shared information providing method according to various embodiments.

According to various embodiments, in operation 405, the first electronic device 10 may transmit shared information to the server 30. For example, the first electronic device 10 may transmit shared data including the shared information to the server 30. According to an embodiment, the first electronic device 10 may transmit the shared information to the server 30 based on a user input. For example, the user input may indicate sharing or transmission of shared data. For another example, the user input may indicate editing (e.g., addition, creation, deletion, and/or change) of shared data. For another example, the user input may include clipping of a web page, setting a web video to watch later, sharing of a web page, and/or adding a web page to a bookmark. According to an embodiment, the first electronic device 10 may transmit the shared information to the server 30 based on a specified event. For example, the specified event may include turning on the first electronic device 10, connection of the first electronic device 10 to a network (e.g., specified network), and/or specified period (e.g., device synchronization period).

According to various embodiments, the server 30 may generate secondary information associated with received shared information. In operation 410, the server 30 may generate meta data (e.g., secondary information) based on the shared information and/or device attribute information.

According to an embodiment, the server 30 may classify the received shared information using an AI module (e.g., the AI module 32 of FIG. 3). For example, the server 30 may classify a type of content (e.g., attribute (e.g., text, video, image, and/or audio) and/or category (e.g., topic and/or at least one keyword)) corresponding to the received shared information. The server 30 may generate type information about content of the shared information as the meta data. For example, the server 30 may determine a category of the content by recognizing an object included in an image based on image recognition (e.g., image recognition based on machine learning). For another example, the server 30 may obtain additional information (e.g., image acquisition place and/or image acquisition time) about an image using image information (e.g., exchangeable image file format (EXIF)) included in the image, and may determine the category of the content further using the additional information. For another example, the server 30 may obtain environmental information such as place information and/or weather information based on image recognition, and may determine the category of the content further using the environmental information.

According to an embodiment, the server 30 may generate the meta data based on shared information. For example, the server 30 may generate, as the meta data, the type and/or category of content included in the shared information.

According to an embodiment, the server 30 may generate the meta data based on the shared information and device attribute. For example, the server 30 may classify the type and/or category of content corresponding to the shared information according to device attributes. For example, the server 30 may generate the meta data including information indicative of which content corresponds to which device attribute. According to an embodiment, the server 30 may store the received shared information and the meta data associated with the shared information in the database 34.

According to various embodiments, the server 30 may transmit the shared information and the meta data to electronic devices belonging to the same account as the first electronic device 10. According to an embodiment, in operation 415, the server 30 may transmit the shared information and the meta data to the second electronic device 20.

According to various embodiments, an electronic device that has received the shared information and the meta data may provide (e.g., display on a display) the shared information to the user based on the device attribute of the electronic device. According to an embodiment, in operation 420, the second electronic device 20 may provide the shared information to the user using the meta data and the device attribute of the second electronic device 20. For example, the second electronic device 20 may reconfigure the shared information based on the meta data and the device attribute and may provide the reconfigured shared information. For another example, the second electronic device 20 may reconfigure at least a portion of the shared information using at least a portion of the meta data and the attribute information about the second electronic device 20, and may display at least the reconfigured portion of the shared information.

According to an embodiment, in operation 425, the server 30 may transmit the shared information and the meta data to the first electronic device 10.

According to an embodiment, the server 30 may transmit the same shared information and meta data to electronic devices (e.g., the first electronic device 10 and the second electronic device 20) associated with the server 30. For example, in operations 415 and 425, the shared information and the meta data transmitted to each of the second electronic device 20 and the first electronic device 10 may be the same. For example, the server 30 may generate the meta data based on the device attribute of the first electronic device 10 and/or the device attribute of the second electronic device 20, and may transmit the generated meta data to the first electronic device 10 and the second electronic device 20.

According to an embodiment, the server 30 may transmit different pieces of meta data to electronic devices (e.g., the first electronic device 10 and the second electronic device 20) associated with the server 30 according to attributes of the electronic devices. For example, in operation 410, the server 30 may generate meta data that is based on the device attribute of the first electronic device 10 and metadata that is based on the device attribute of the second electronic device 20. In operation 415, the server 30 may transmit the meta data that is based on the device attribute of the second electronic device 20. In operation 420, the server 30 may transmit the meta data that is based on the device attribute of the first electronic device 10. In this case, the meta data transmitted in operation 415 and the meta data transmitted in operation 425 may be different from each other.

According to an embodiment, in operation 430, the first electronic device 10 may provide the shared information using the meta data and the device attribute of the first electronic device 10.

For example, when the first electronic device 10 and the second electronic device 20 have received the same shared information and meta data, the first electronic device 10 may provide the shared information in a manner different from that of the second electronic device 20 since the first electronic device 10 and the second electronic device 20 have different device attributes. For another example, when the first electronic device 10 and the second electronic device 20 have received different pieces of meta data, the first electronic device 10 may provide the shared information in a manner different from that of the second electronic device 20 since the pieces of meta data were generated based on different device attributes of the first electronic device 10 and the second electronic device 20.

For another example, reconfiguration of the shared information may be performed by the server 30. For example, the server 30 may generate reconfiguration information about the shared information based on the meta data and the device attribute of the second electronic device 20, and may transmit the generated reconfiguration information to the second electronic device 20. For example, the second electronic device may display the shared information using the received reconfiguration information.

According to an embodiment, an electronic device (e.g., the first electronic device 10 and/or the second electronic device 20) may provide the shared information to the user further based on the meta data, the device attribute, and a user setting. For example, an electronic device may reconfigure the shared information in consideration of not only the meta data and the device attribute but also the user setting. For example, the user setting may reconfigure the shared information based on a user preference setting (e.g., preferred topic, preferred form, and/or prohibited topic) and/or shared data reconfiguration setting (e.g., provision of reconfigured shared data or provision of original shared data).

According to an embodiment, an electronic device (e.g., the first electronic device 10 and/or the second electronic device 20) may provide the shared information to the user further based on recognition of an external electronic device. For example, an electronic device may recognize a nearby external electronic device based on neighbor awareness network (NAN), Wi-Fi, Bluetooth, ultra-wideband (UWB), infrared, visible light, sound waves, ultrasound, electromagnetic (EM) sensing, and/or light pattern. For another example, an electronic device may recognize an external electronic device based on GPS information, indoor positioning, and/or image recognition. According to an embodiment, an electronic device may provide the shared information based on the device attribute of a nearby external electronic device. For example, when a refrigerator is detected near an electronic device, the electronic device may preferentially provide information such as calorie information and/or diet information among pieces of the shared information, further based on the device attribute (e.g., food) of the refrigerator.

According to an embodiment, the user may designate an electronic device (e.g., the second electronic device 20) or electronic device group with which shared data is to be shared. The first electronic device 10 may transmit information about the electronic device or electronic device group designated for sharing to the server 30 together with shared data. In this case, the server 30 may transmit meta data and shared data only to the designated device or electronic device group.

According to an embodiment, the user may designate an electronic device or electronic device group to be prohibited from sharing shared data. The first electronic device 10 may transmit information about the electronic device or electronic device group prohibited from sharing to the server 30 together with shared data. In this case, the server 30 may transmit the meta data and shared data described below only to an electronic device not corresponding to the electronic device and group prohibited from sharing.

According to various embodiments, the server 30 may further generate additional information based on received shared information. According to an embodiment, the server 30 may generate the additional information (e.g., data associated with shared information or a data access address for accessing data associated with shared information) based on the shared information and the device attribute of an electronic device (e.g., the second electronic device 20) with which the shared information is to be shared. For example, the server 30 may transmit the additional information to other electronic device together with the meta data and shared information. For example, pieces of the additional information transmitted to the first electronic device 10 and the second electronic device 20 may be different from each other.

According to an embodiment, the server 30 may extract at least one keyword from content corresponding to the shared information, and may perform a search (e.g., web search) based on the extracted keyword and the device attribute to receive the additional information. The server 30 may generate the additional information based on a search result. Therefore, when the device attributes of the first electronic device 10 and the second electronic device 20 are different from each other, the additional information for the first electronic device 10 and the additional information for the second electronic device 20 may be different from each other.

According to various embodiments, the shared information may be bookmark information about the first electronic device 10. For example, the shared data may include a plurality of web page addresses.

According to an embodiment, when the user adds a particular web page to a bookmark of a web browser while surfing the web using the first electronic device 10, the first electronic device 10 may transmit shared data including bookmark information to the server 30 (e.g., operation 405).

According to an embodiment, the server 30 may determine attribute information (e.g., video, still image, external link, and/or text) and a category (e.g., topic and/or keyword) of content (e.g., content of a web page corresponding to bookmark information) of received shared data. For example, the server 30 may classify the shared data using an AI technology. The server 30 may classify a category (e.g., topic and/or keyword) to which the content of the shared data belongs and/or an attribute (e.g., video, still image, external link, and/or text) of the content. For example, the server 30 may classify the category of the content of the shared data using image information and/or text information about a web page corresponding to the shared data. For example, the server 30 may determine a content attribute for the corresponding web page based on a link connected to an image file, video file, and/or music file of the content of the shared data.

According to an embodiment, the server 30 may generate attribute information and content category information about the shared data as meta data (e.g., operation 410). According to an embodiment, the server 30 may generate, as meta data, attribute information and content category information about the shared data classified according to the device attribute.

Hereinafter, various methods for providing shared data will be described using bookmark information as an example. The bookmark information is an example of shared data, and embodiments of the present disclosure are not limited thereto. For example, when data such as a picture and/or video is shared via a cloud server (e.g., the server 30), the second electronic device 20 may reconfigure and provide a picture and/or video based on at least the device attribute of the second electronic device 20.

[symbol]

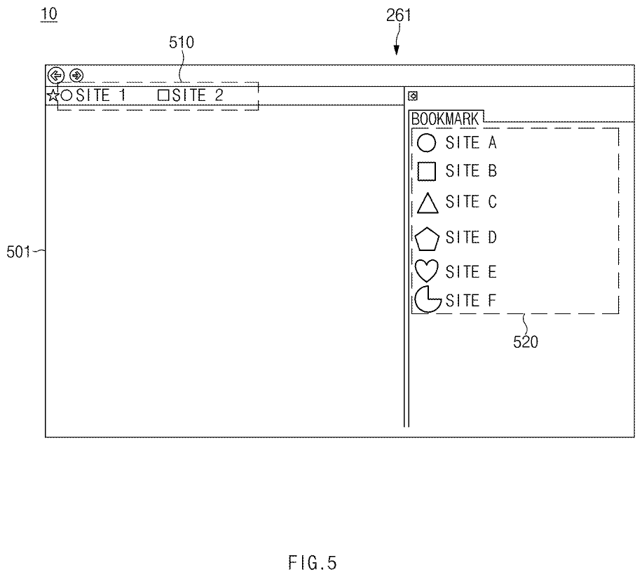

FIG. 5 illustrates a first UI 501 according to an embodiment.

In FIG. 5, the first electronic device 10 may display the first UI 501 on the display 261. According to an embodiment, the first electronic device 10 may be a PC. For example, the first UI 501 may be a UI screen of a web browser executed by the first electronic device 10. For example, the first UI 501 may include a first bookmark region 510 and a second bookmark region 520. According to an embodiment, the first electronic device 10 may transmit first bookmark information (e.g., information (e.g., uniform resource locator (URL) or uniform resource indicator (URI)) about SITE 1 and/or SITE 2) included in the first bookmark region 510 and second bookmark information (e.g., information (e.g., URL or URI) about SITE A, SITE B, SITE C, SITE D, SITE F, and/or SITE F) included in the second bookmark region 520 to the server 30 as shared data. Hereinafter, the shared data may be the second bookmark information included in the second bookmark region 520.

For example, the first electronic device 10 may sort web pages of the second bookmark information included in the second bookmark region 520 in the order in which the web pages were bookmarked, and may provide the web pages. According to various embodiment, when the second bookmark information is shared with another electronic device (e.g., the second electronic device 20), the other electronic device may sort the second bookmark information in a manner different from that of the first electronic device 10 according to the device attribute and may display the second bookmark information. For example, when shared information is displayed by a TV, the TV may preferentially sort and display shared data including a video among pieces of shared data by using the device attribute of the TV and content attribute information of meta data. For another example, when shared information is displayed by a refrigerator, the refrigerator may preferentially sort and display shared data associated with food among pieces of shared data by using the device attribute of the refrigerator and a content category of meta data.

The sorting of the shared data is an example of reconfiguration of the shared data, and embodiments of the present disclosure are not limited thereto. According to various embodiments, the second electronic device 20 may select a method for displaying shared data using the meta data and device attribute. For example, the second electronic device 20 may reconfigure or reprocess shared data according to a selected method for displaying shared data. According to an embodiment, the second electronic device 20 may differently set not only a method for re-sorting web pages included in shared data but also a method for display each web page.

[symbol]

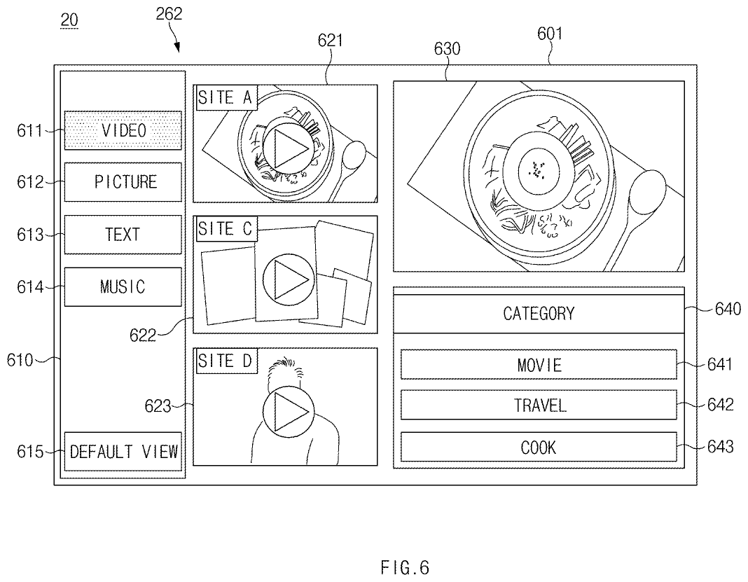

FIG. 6 illustrates a second UI 601 according to an embodiment.

In FIG. 6, the second electronic device 20 may display the second UI 601 on the display 262. According to an embodiment, the second electronic device 20 may be a TV. For example, the second UI 601 may be a screen for displaying shared data (e.g., the second bookmark information included in the second bookmark region 520 of FIG. 5) received from the server 30. According to various embodiments, the second electronic device 20 may reconfigure the shared data using content attribute information of meta data received from the server 30. For example, the second electronic device 20 may determine a video web page (e.g., a web page including a video link address) including a video among web pages using the content attribute information, and may preferentially display the video web page on the second UI 601.

According to an embodiment, the second electronic device 20 may reconfigure the shared data based on a device attribute. For example, when sites A, C, and D among pieces of the shared data include a video, the second electronic device 20 may preferentially sort and display the sites A, C, and D on the second UI 601. For example, the second electronic device 20 may provide representative images (e.g., 621, 622, and 623) of videos included in the sites A, C, and D instead of providing header information (e.g., page title) about a web page. According to an embodiment, the second electronic device 20 may provide a preview 630 for a video corresponding to the representative image 621 of the selected site A among the representative images 621, 622, and 623.

According to various embodiments, the second electronic device 20 may display the shared information further considering a user setting.

According to an embodiment, the second UI 601 may include an attribute setting UI 610. For example, the second electronic device 20 may provide, to the second UI 601, shared data corresponding to an attribute selected using the content attribute information of meta data. For example, when a video 611 is selected, the second electronic device 20 may preferentially display, on the second UI 601, web pages including a video among pieces of shared data. For another example, when a picture 612 is selected, the second electronic device 20 may preferentially display, on the second UI 601, web pages including a pictures among pieces of shared data. In this case, the second electronic device 20 may change the representative images 621, 622, and 623 to pictures. For another example, when a text 613 is selected, the second electronic device 20 may preferentially display, on the second UI 601, web pages including a text among pieces of shared data. In this case, the second electronic device 20 may change the representative images 621, 622, and 623 to text (e.g., web page title and/or keyword) corresponding to a web page. For another example, when a music 614 is selected, the second electronic device 20 may preferentially display, on the second UI 601, web pages including music among pieces of shared data. In this case, the second electronic device 20 may change the representative images 621, 622, and 623 to images (e.g., an album cover or an image of an author) associated with music. For another example, when a default view 615 is selected, the second electronic device 20 may display the shared data on the second UI 601 without reconfiguring the shared data. For example, the second electronic device 20 may display web pages in the same order as that of the second bookmark information of the second region 520 of the first UI 501 of FIG. 5. Although FIG. 6 illustrates three representative images 621, 622, and 623, embodiments of the present disclosure are not limited thereto. According to various embodiments, the second UI 601 may include at least one representative image. For example, the number of representative images included in the second UI 601 may be set in advance. For another example, the number of representative images included in the second UI 601 may be variable. According to an embodiment, the second electronic device 20 may change a size of each of representative images according to the number of representative images included in the second UI 601. For example, the second electronic device 20 may reduce the size of each of representative images (e.g., 621, 622, and 623) as the number of representative images increases.

According to an embodiment, the second UI 601 may include a category setting UI 640. For example, the second electronic device 20 may provide, to the second UI 601, shared data corresponding to a category selected using the content category information of meta data. For example, when a movie 641 is selected, the second electronic device 20 may preferentially display, on the second UI 601, web pages including content having a content attribute corresponding to a movie among pieces of shared data. For another example, when a travel 642 is selected, the second electronic device 20 may preferentially display, on the second UI 601, web pages including content having a topic corresponding to a travel among pieces of shared data. For another example, when cooking 643 is selected, the second electronic device 20 may preferentially display, on the second UI 601, web pages including content having a topic of cooking among pieces of shared data.

The form of the second UI 601 of FIG. 6 is illustrative, and embodiments of the present disclosure are not limited thereto. According to an embodiment, at least one of the attribute setting UI 610, the preview 630, and/or the category setting UI 640 may be omitted. For example, the attribute setting UI 610 may be omitted. For another example, the preview 630 may be omitted. For another example, the category setting UI 640 may be omitted. For another example, the attribute setting UI 610 and the preview 630 may be omitted. For another example, the attribute setting UI 610 and the category setting UI 640 may be omitted. For another example, the preview 630 and the category setting UI 640 may be omitted. For another example, the attribute setting UI 610, the preview 630, and the category setting UI 640 may be omitted.

[symbol]

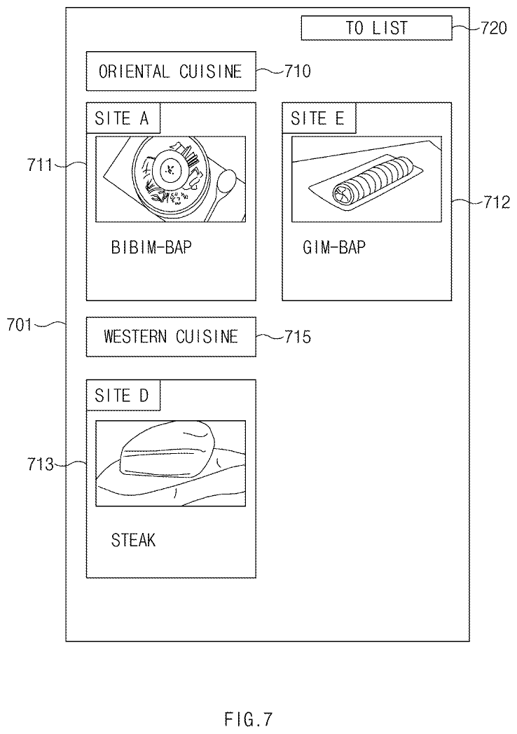

FIG. 7 illustrates a third UI 701 according to an embodiment.

In FIG. 7, the second electronic device 20 may display the third UI 701 on the display 262. According to an embodiment, the second electronic device 20 may be a refrigerator. For example, the third UI 701 may be a screen for displaying shared data (e.g., the second bookmark information of the second region 520 of FIG. 5) received from the server 30. According to various embodiments, the second electronic device 20 may reconfigure the shared data using content category information of meta data received from the server 30. For example, the second electronic device 20 may determine a web page (e.g., a web page having a topic of food, cooking, recipe, and/or food material) related to food using the content category information, and may preferentially display the web page related to food on the third UI 701.

According to an embodiment, the second electronic device 20 may reconfigure the shared data based on a device attribute. For example, when sites A, D, and E among pieces of the shared data are web pages related to food, the second electronic device 20 may preferentially sort and display the sites A, D, and E on the third UI 701. For example, the second electronic device 20 may provide images (e.g., 711, 712, and 713) of cuisine included in the sites A, D, and E instead of providing header information (e.g., page title) about a page.

According to various embodiments, the second electronic device 20 may display the shared information further considering a user setting. For example, the second electronic device 20 may separately display an oriental cuisine 710 and a western cuisine 715. For example, the second electronic device 20 may display cuisine images 711 and 712 included in the site A and site E as the western cuisine 710 and may display a cuisine image 713 included in the site D as the western cuisine 715. For example, upon receiving an input to a list 720, the second electronic device 20 may display web pages in the same order as that of the second bookmark information of the second region 520 of the first UI 501 of FIG. 5.

The form of the third UI 701 of FIG. 7 is illustrative, and embodiments of the present disclosure are not limited thereto. For example, the third UI 701 may further include a UI for setting a category.

[symbol]

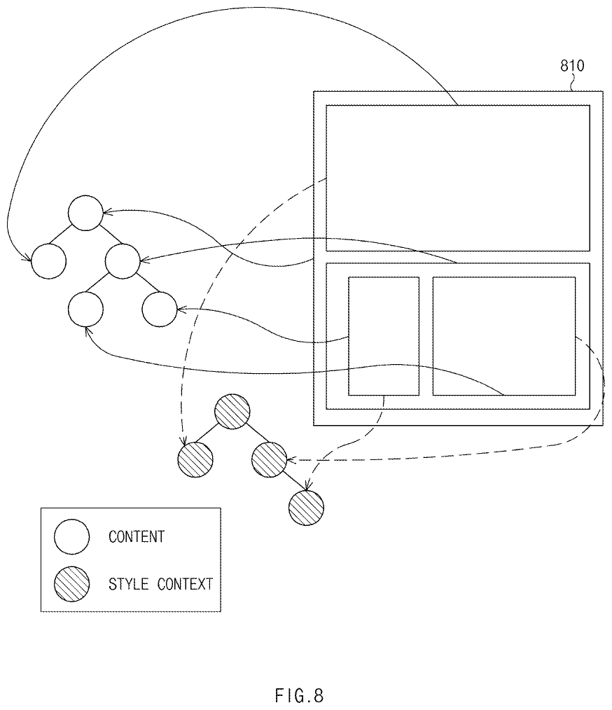

FIG. 8 illustrates a configuration of shared information according to various embodiments.

According to various embodiments, an electronic device (e.g., the first electronic device 10, the second electronic device 20, and/or the server 30) may reconfigure content of shared data based on a hypertext markup language (HTML) standard (e.g., refer to www.w3.org/TR/2014/REC-html5-20141028). For example, an electronic device may display content (e.g., web page) of shared data based on a frame structure 810 including at least one frame, content to be displayed in each frame, and a style context indicating a method for displaying content in each frame. According to an embodiment, an electronic device may reconfigure the content of shared data by changing at least one of the content, the style context, and/or the frame structure 810. For example, an electronic device may change layout of the content by removing partial content or changing the frame structure 810.

[symbol]

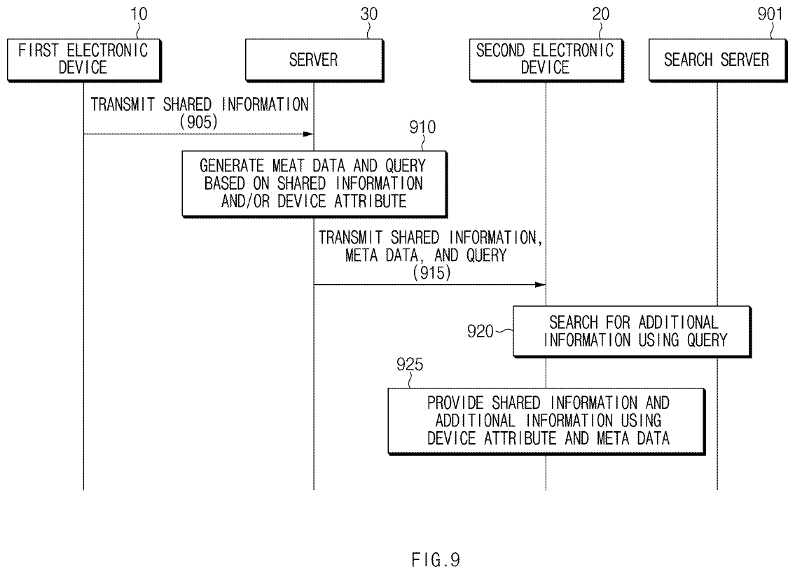

FIG. 9 is a signal flowchart illustrating a method for providing shared information and additional information according to various embodiments.

According to various embodiments, an electronic device (e.g., the first electronic device 10 or the second electronic device 20) may further provide, to the user, additional information associated with shared data.

According to an embodiment, in operation 905, the first electronic device 10 may transmit shared information (e.g., favorites information of the first region 510 and/or the second region 520 of FIG. 5) to the server 30. For example, the first electronic device 10 may transmit the shared information to the server 30 in the same manner as operation 405 of FIG. 4.

According to an embodiment, in operation 910, the server 30 may generate meta data and a query based on the shared information and/or device attribute information. For example, the server 30 may generate the meta data in the same manner as operation 410 of FIG. 4. According to an embodiment, the server 30 may generate at least one query based on a topic of content corresponding to the shared information, a summary of the content, and/or the type of the content. According to an embodiment, at least one query may be generated as a portion of the meta data.

According to an embodiment, in operation 915, the server 30 may transmit the shared information, the meta data, and the query to the second electronic device 20. In operation 920, the second electronic device 20 may searches a search server 901 for additional information associated with content using the received query. According to an embodiment, the second electronic device 20 may searches for the additional information using the received query and the device attribute of the second electronic device 20. According to an embodiment, the query for searching for the additional information may vary according to the device attribute, or different search results may be achieved for the same query.

According to an embodiment, in operation 925, the second electronic device 20 may provide the shared information and additional information using the device attribute and the meta data. For example, the second electronic device 20 may reconfigure the shared information using the device attribute and the meta data, and may provide the additional information that is based on a search result together with the reconfigured shared information. According to an embodiment, the second electronic device 20 may provide, to the user, at least one query used to search for the additional information together with the additional information.

For example, the server 30 may receive, from the first electronic device 10, a web page related to spaghetti as shared data. In this case, the server 30 may generate “spaghetti” as query information extracted from the web page. According to an embodiment, the second electronic device 20 may obtain the additional information using the device attribute of the second electronic device 20, the meta data, and the query information. For example, the second electronic device 20 may generate an additional query based on the device attribute and the meta data. For example, in the case where the second electronic device 20 is a refrigerator, the second electronic device 20 may generate additional queries “video” and “recipe” based on the meta data (e.g., content attribute information of meta data) and the device attribute. According to an embodiment, the second electronic device 20 may perform a web search with “spaghetti”, “video”, and “recipe” as search words using the received query information (e.g., “spaghetti”) and additional queries (e.g., “video” and “recipe”). For example, the second electronic device 20 may obtain the additional information based on at least a web search result.

In the embodiment of FIG. 9, the server 30 may provide the query information for obtaining the additional information to other electronic devices. According to another example, as described above with reference to FIG. 4, the server 30 itself may obtain the additional information and may provide the obtained additional information to other electronic devices.

According to various embodiments, the second electronic device 20 may provide an additional service that is based on the additional information to the user using the additional information searched for or the additional information received from the server 30. For example, in the case where the second electronic device 20 is a refrigerator, the second electronic device 20 may obtain a recipe for spaghetti as the additional information. According to an embodiment, the second electronic device 20 may provide an additional information-based additional service based on the additional information and the context information about the second electronic device 20. For example, the second electronic device 20 may compare material information (e.g., context information) stored in the second electronic device 20 with the recipe of the additional information. According to an embodiment, the second electronic device 20 may provide a user notification as the additional service based on the context information and the additional information. For example, the second electronic device 20 may provide information about an insufficient material to the user. For another example, the second electronic device 20 may provide a user interface for purchasing an insufficient material.

[symbol]

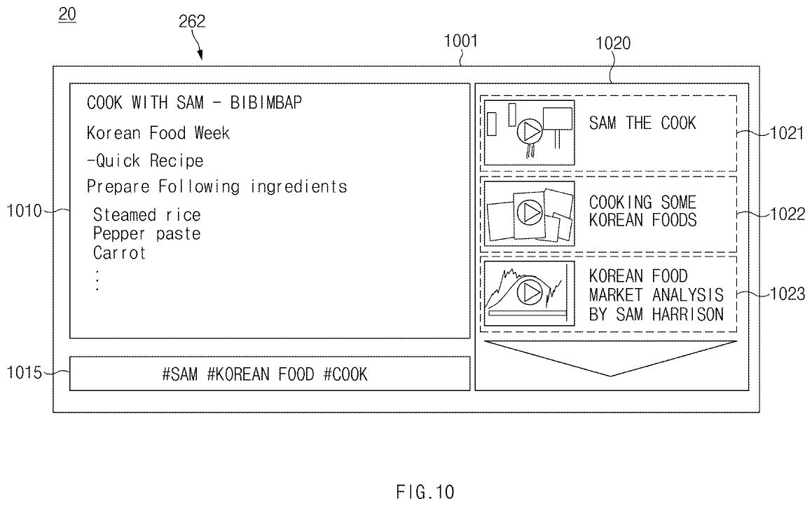

FIG. 10 illustrates a fourth UI 1001 according to an embodiment.

According to various embodiments, the second electronic device 20 may provide shared data and additional information. For example, the first electronic device 10 may transmit, to the server 30, the second bookmark information of the second region 520 of FIG. 5 as the shared data, and the server 30 may transmit, to the second electronic device 20, the shared data received from the first electronic device 10. For example, the second electronic device 20 may be a TV. According to an embodiment, the second electronic device 20 may display the fourth UI 1001 including additional information and at least a portion of shared information through the display 262.

According to an embodiment, the second electronic device 20 may display content of the shared information in a first region 1010. For example, the content of the shared information may be a cooking guide of a person called “SAM”.

For example, the second electronic device 20 may identify, as query information, “Korean food” corresponding to a keyword (e.g., a category of content) of the content from the server 30. According to an embodiment, the second electronic device 20 may identify an additional query using the meta data (e.g., content attribute) and the device attribute of the second electronic device 20. For example, the second electronic device 20 may identify at least a portion of information from content of shared data using the content attribute and the attribute of the second electronic device 20. The second electronic device 20 may determine, from the content of the shared data, an additional query that is different from the query information indicated by the meta data. For example, the second electronic device 20 may identify an additional query “SAM” that is a portion of text of the content by extracting a portion (e.g., keyword) of the content based on an attribute (e.g., text) of the content. For example, the second electronic device 20 may identify a keyword (e.g., person and/or news) corresponding to the device attribute of the second electronic device 20 in the text of the content. According to an embodiment, the second electronic device 20 may display the query information and additional query in a second region 1015.

According to an embodiment, the second electronic device 20 may perform a web search using the query information and the additional query, and may provide a web search result as the additional information. For example, the second electronic device 20 may display, in a third region 1020, first additional information 1021, second additional information 1022, and third additional information 1023 including content (e.g., video) corresponding to the attribute information of the second electronic device 20 among results of a search performed using the query information and the additional query. For another example, the second electronic device 20 may perform a web search using the query information, the additional query, and the device attribute (e.g., video), and may display a search result in the third region 1020.

For example, upon receiving an input to one (e.g., the first additional information 1021, the second additional information 1022, or the third additional information 1023) of objects displayed in the third region 1020, the second electronic device 20 may play a video corresponding to the received input in a full screen.

According to an embodiment, the second electronic device 20 may display the additional information based on at least the device attribute. The second electronic device 20 may reconfigure the additional information based on the device attribute and may display the reconfigured additional information. For example, the second electronic device 20 may reconfigure and display the additional information with respect to a video based on the device attribute.

[symbol]

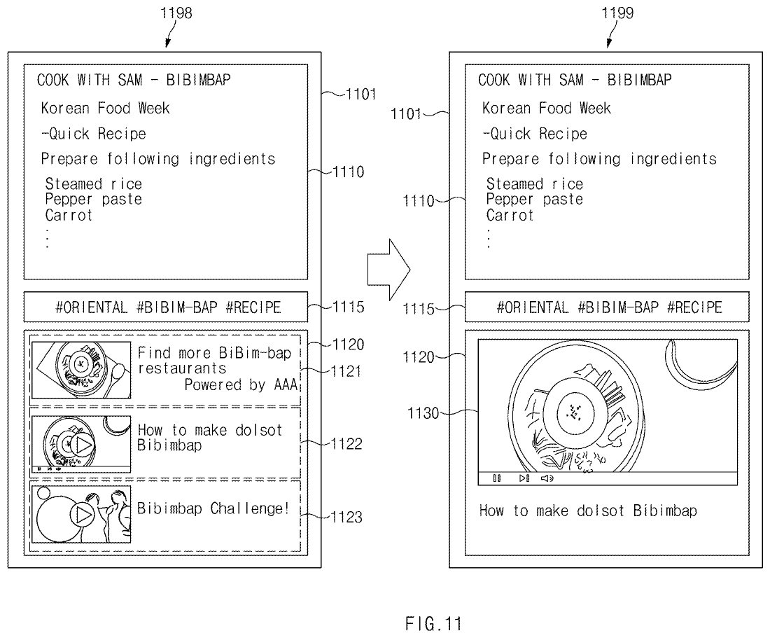

FIG. 11 illustrates a fifth UI 1101 according to an embodiment.

According to various embodiments, the second electronic device 20 may provide shared data and additional information. For example, the first electronic device 10 may transmit, to the server 30, the second bookmark information of the second region 520 of FIG. 5 as the shared data, and the server 30 may transmit, to the second electronic device 20, the shared data from the first electronic device 10. The second electronic device 20 may be a refrigerator. According to an embodiment, as indicated by reference numeral 1198, the second electronic device 20 may display the fifth UI 1101 including additional information and at least a portion of shared information. The content of the shared information may be the same as illustrated in FIG. 10. The second electronic device 20 may display the content of the shared information in a first region 1110.

For example, the second electronic device 20 may obtain, as query information, “Korean food” corresponding to a keyword (e.g., a category of content) of the content from the server 30. According to an embodiment, the second electronic device 20 may obtain an additional query using the meta data (e.g., content category and attribute) and the device attribute of the second electronic device 20. For example, the second electronic device 20 may obtain “recipe” as the additional query by generating a keyword associated with the content based on the device attribute and a category (e.g., cooking) of the content. The second electronic device 20 may obtain “bibim-bap” as the additional query by extracting a keyword associated with the content based on the device attribute and an attribute (e.g., text) of the content. According to an embodiment, the second electronic device 20 may display the query information and additional query in a second region 1115. For another example, the second region 1115 may be omitted.

According to an embodiment, the second electronic device 20 may perform a web search using the query information and the additional query, and may provide a web search result as the additional information. For example, the second electronic device 20 may provide advertisement information associated with the query information and/or the additional query as first additional information 1121 as the additional information. For example, the first additional information 1121 may be provided by a third-party provider. According to an embodiment, the second electronic device 20 may display, in a third region 1120, second additional information 1122 and third additional information 1123 in addition to the first additional information 1121.

According to an embodiment, the second electronic device 20 may provide, to the user, corresponding additional information in response to an input to one of the pieces of additional information of the third region 1120. For example, as indicated by reference numeral 1199, the second electronic device 20 may play a video 1130 corresponding to at least a portion of the third region 1120 in response to a user input to the second additional information 1122. In this case, for example, the second electronic device 20 may maintain a display of at least a portion of the content of the shared data in the first region 1110. For another example, the second electronic device 20 may change a configuration of the fifth UI 1101 in response to a user input to the second additional information 1122. For example, the second electronic device 20 may play the video 1130 in a full screen on a display (e.g., the display 262 of FIG. 2) of the second electronic device 20. For another example, the second electronic device 20 may change a size and/or location of the first region 1110, the second region 1115, and/or the third region 1120.

As described above with reference to FIGS. 10 and 11, even if the second electronic device 20 obtains the same shared data and query, the second electronic device 20 may provide different additional information according to the device attribute since the additional query is obtained based on the device attribute.

According to an embodiment, the shared data received by the second electronic device 20 (e.g., a refrigerator, TV, or camera) may be an address of a blog related to travel to Greece. For example, when accessing content of shared data in a refrigerator (e.g., when accessing a corresponding blog), the refrigerator may provide information (e.g., recipe information) related to Greek cuisine as the additional information. For another example, when accessing content of shared data in a TV, the TV may provide a video related to Greece as the additional information. For another example, when accessing content of shared data in a camera, the camera may provide a picture related to Greece as the additional information.

According to an embodiment, the shared data received by the second electronic device 20 (e.g., a refrigerator, TV, or camera) may be an address of a blog related to Greek food. For example, when accessing content of shared data in a refrigerator, the refrigerator may provide information related to a food material of the content as the additional information. The refrigerator may provide, as the additional information, information (e.g., insufficient food material information) indicating a current situation of food in the refrigerator and/or whether the food material of the content can be cooked. For another example, when accessing content of shared data in a TV, the TV may provide, as the additional information, information about a TV program related to Greek food. For another example, when accessing content of shared data in a camera, the camera may provide a picture related to Greek food as the additional information.

[symbol]

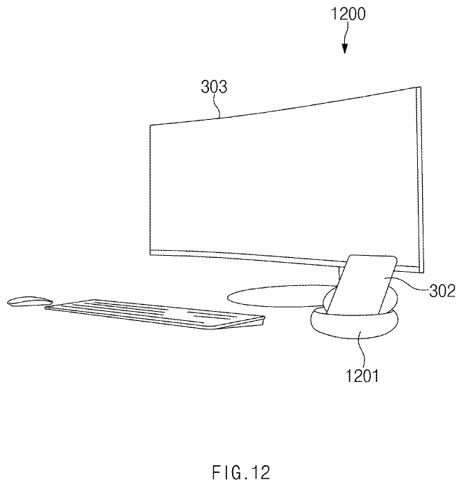

FIG. 12 illustrates a second electronic device in a shared data output environment 1200 according to an embodiment.

In the example of FIG. 12, the second electronic device 20 is assumed to be a smartphone 302. According to an embodiment, the second electronic device 20 may output content to a display of a PC 303 via a peripheral device 1201. For example, the smartphone 302 may receive, via the server 30, shared information transmitted from the first electronic device 10.

According to various embodiments, the second electronic device 20 may provide shared data using not only the device attribute of the second electronic device 20 but also the device attribute of another electronic device operatively connected by wire or wirelessly to the second electronic device 20. For example, the second electronic device 20 (e.g., the smartphone 203) may be connected to an external electronic device (e.g., TV) by wire (HDMI or MHL) or wirelessly (e.g., WiFi). In this case, the second electronic device 20 may provide the shared data using the device attribute of a TV. Referring to FIG. 12, the second electronic device 20 may be connected to the PC 303 via the peripheral device 1201. The second electronic device 20 may generate shared information and/or additional information using, instead of the device attribute of the smartphone 302, the device attribute of the PC 303 that is a device to which content is currently output

According to an embodiment, the second electronic device 20 may determine a method for displaying shared data based on the device attribute of an external electronic device (e.g., the PC 303) in which the shared data is to be displayed. For example, the second electronic device 20 may change a device attribute for temporarily providing the shared data while connected to the external electronic device to the device attribute of the external electronic device. In the example of FIG. 12, the smartphone 302 may provide the shared data substantially in the same manner as that in which the shared data is provided by the PC 303.

According to various embodiments, the server 30 may generate meta data using the device attribute of another electronic device operatively connected by wire or wirelessly to the second electronic device 20. For example, the server 30 may recognize that the second electronic device 20 (e.g., the smartphone 302) is connected to the PC 303 via the peripheral device 1201. In this case, the server 30 may generate additional information using, instead of the device attribute of the smartphone 302, the device attribute of the PC 303 that is a device to which content is currently output. For example, the server 30 may transmit, to the smartphone 302, the additional information generated using the device attribute of the PC 303 and the shared information. The smartphone 302 may output the shared information to the PC 303 using the received additional information.

[symbol]

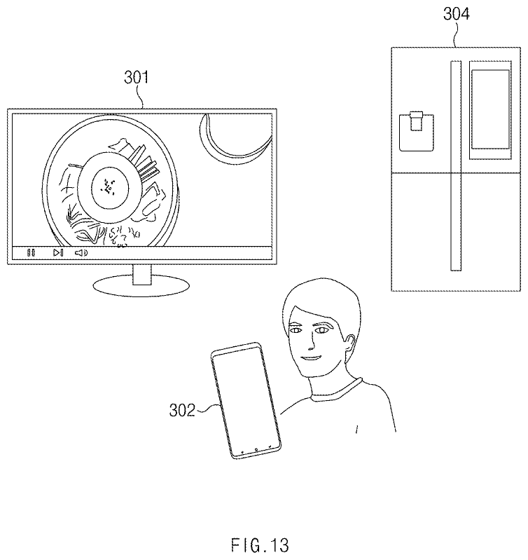

FIG. 13 illustrates a data sharing environment according to an embodiment.

According to various embodiments, each electronic device (e.g., the TV 301, the mobile phone 302, or the refrigerator 304) may collect a user input and/or user manipulation information for the electronic device. According to an embodiment, the electronic device may transmit, as shared data, the user input and/or user manipulation information for the electronic device. For example, the mobile phone 302 may transmit, to the server 30, a user search record and/or user usage record as shared information.

According to an embodiment, an external electronic device (e.g., the refrigerator 304) that has received shared information from the server 30 may determine at least a portion of shared information associated with the external electronic device from the shared information based on the device attribute of the external electronic device, and may reconfigure and provide at least the portion of shared information to the user.

According to an embodiment, an external electronic device (e.g., the refrigerator 304) that has received shared information from the server 30 may determine at least a portion of shared information associated with the external electronic device from the shared information based on the device attribute of the external electronic device, and may provide additional information based on at least the portion of shared information.

According to an embodiment, the server 30 extracts, from shared data, data associated with each of electronic devices belonging to the same account through data mining, and may transmit the extracted data to each of the electronic devices.

For example, the TV 301 may transmit a TV watching record of the user as shared data, and the mobile phone 302 may transmit a search record of the user as shared data. The server 30 may transmit received shared data to the refrigerator 304 associated with the same account as the TV 301 and the mobile phone 302. For example, when the TV watching record indicates a program for children and the search records includes baby food, the refrigerator 304 may obtain additional information from shared information. For example, the refrigerator 304 may obtain a recipe for baby food using the shared information. In this case, usability for the user may be improved by providing information based on activity information about the user, and, furthermore, an advertisement that meets the needs of the user may be provided.

For example, an electronic device may provide, to the user, shared data or additional information reconfigured based on a user's request. For another example, an electronic device may provide, to the user, shared data or additional information reconfigured based on an implicit request. An electronic device may provide, to the user, shared data or additional information reconfigured based on user's approach or user's contact. For example, in the case where an electronic device is a refrigerator, the refrigerator may provide, to the user, shared data or additional information reconfigured based on opening/closing of a door of the refrigerator and/or user's approach to the refrigerator.

According to various embodiments, the user may choose to share shared data for a particular electronic device. According to an embodiment, while viewing the TV 301, the user may instruct the TV 301 to share data associated with current content with the refrigerator 304. For example, the user may instruct the TV 301 to share data through a voice command. For example, the data associated with content may be an image corresponding to a video being viewed currently. According to an embodiment, the TV 301 may share, with the refrigerator 304, content (e.g., data associated with content) collected based on a user's voice command and additional information that is based on content analysis. For example, the TV 301 may share, with the refrigerator 304, information (e.g., recipe, cuisine name, and/or cooking material) and/or image of cuisine identified from an image.

For example, the user may find cuisine that the user likes while viewing a video in which cuisine appears by using the TV 301. The user may request, through a voice command, the TV 301 to register a recipe for cuisine being viewed in a “meal planner”.

According to an embodiment, the TV 301 may determine, based on a user's voice command, a device for which sharing is to be allowed. For example, the TV 301 may identify that the device for which sharing is to be allowed is the refrigerator 304 by identifying the “meal planner” from the voice command. For another example, the TV 301 may identify that the device for which sharing is to be allowed is the refrigerator 304 by transmitting at least a portion of the voice command to the server 30 and identifying the “meal planner” indicated by a voice command result from the server 30 or receiving information about a refrigerator identified by the server 30. According to an embodiment, the TV 301 may identify cuisine to be shared based on image analysis. For example, the TV 301 may identify cuisine to be shared by analyzing at least one image currently output to a display. For another example, the TV 301 may identify cuisine to be shared by transmitting, to the server 30, at least one image currently output to a display and receiving an image analysis result from the server 30. For another example, the TV 301 may identify cuisine to be shared by transmitting, to the server 30, screen information (e.g., time, channel through which playback is being performed, and/or web page through which playback is being performed) and receiving a recognition result that is based on the screen information from the server 30.

According to an embodiment, the TV 301 may transmit, to the server 30, specified application information (e.g., meal planner), identified cuisine information, and information about a device for which sharing is to be allowed as shared information. The server 30 may transmit the received shared information to the refrigerator 304. For example, upon receiving the shared information, the refrigerator 304 may register information about identified cuisine in a specified application (e.g., meal planner). According to an embodiment, the server 30 or the refrigerator 304 may reconfigure the shared information based on the device attribute of the refrigerator 304.

According to an embodiment, the TV 301 may request the user to provide additional information about the shared information. For example, the TV 301 may inquire of the user about schedule information associated with identified cuisine. Upon receiving a user response (e.g., date and time), the TV 301 may transmit, to the server 30, schedule information corresponding to the response together with the shared information. For example, upon receiving the shared information, the refrigerator 304 may register information about identified cuisine in a specified application according to the schedule information.

In the example of FIG. 13, at least a portion of operations performed by the TV 301 may be performed by the server 30. For example, if the TV 301 transmits a voice command and image information (e.g., image and/or screen information being played) to the server 30, the server 30 may identify information about an electronic device (e.g., the refrigerator 304) for which sharing is to be allowed and cuisine to be shared, based on the received voice command and image information. In this case, the server 30 may transmit, to the refrigerator 304, specified application information (e.g., meal planner) and identified cuisine information as shared information.

[symbol]

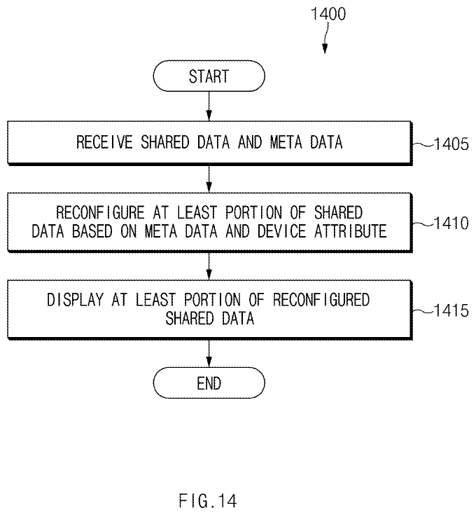

FIG. 14 is a flowchart illustrating a data providing method according to various embodiments.

According to various embodiments, an electronic device (e.g., the second electronic device 20 of FIG. 2) may include a display (e.g., the display 262 of FIG. 2), a communication circuit (e.g., the communication circuit 292 of FIG. 2), a processor (e.g., the processor 222 of FIG. 2) operatively connected to the display and the communication circuit, and a memory (e.g., the memory 232 of FIG. 2) operatively connected to the processor. For example, the memory may store one or more instructions that, when executed, cause the processor of the electronic device to perform the operations described below.

According to various embodiments, in operation 1405, the processor may receive, from an external server device (e.g., the server 30 of FIG. 2), shared data and meta data generated by the external server device using the communication circuit. For example, the shared data may be shared data transmitted by an external electronic device (e.g., the first electronic device 10 of FIG. 2) to the external server device. For example, the external server device may generate the meta data based on the shared data, and may transmit the shared data and the generated meta data to the electronic device. For example, the meta data may include attribute information and category information about content of the shared data. For example, the shared data may include at least one web page address.

According to various embodiments, in operation 1410, the processor may reconfigure at least a portion of the shared data based on the meta data and a device attribute of the electronic device. For example, the attribute of the electronic device may be set based on at least a use of the electronic device. For example, the processor may reconfigure at least a portion of the shared data corresponding to the device attribute based on the meta data. For example, the processor may reconfigure at least a portion of pieces of web content corresponding to a plurality of web page addresses based on the device attribute.

According to various embodiments, in operation 1415, the processor may display at least a portion of the reconfigured shared data on the display. For example, the processor may display at least a portion of pieces of reconfigured web content on the display.

According to an embodiment, the processor may receive query information associated with the shared data from the external server device using the communication circuit, and may further display, on the display, additional information associated with at least a portion of the reconfigured shared data, based on the received query information. For example, the processor may perform a web search using the received query information, and may obtain the additional information based on a result of the web search.

According to an embodiment, the electronic device may be a non-portable multimedia viewing device (e.g., TV). In this case, the processor may reconfigure at least a portion of shared data including multimedia data, among pieces of the shared data, using the multimedia data.

According to an embodiment, the electronic device may be a refrigerator, and the processor may reconfigure at least a portion of shared data including content associated with food or cooking among pieces of the shared data.

[symbol]

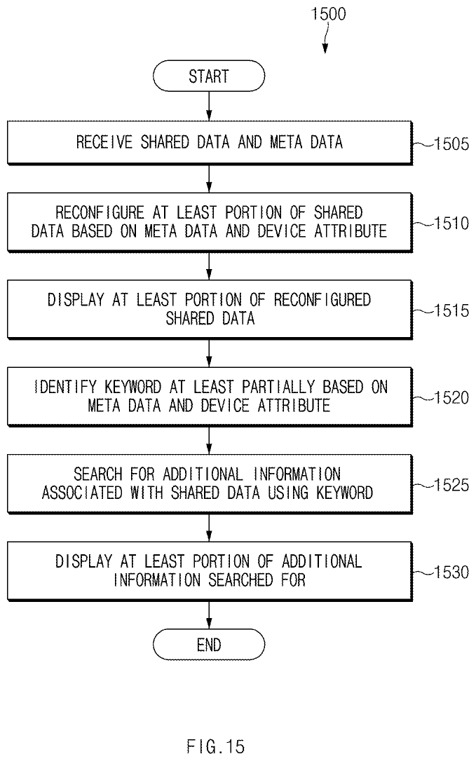

FIG. 15 is a flowchart 1500 illustrating an additional information providing method according to various embodiments.

According to various embodiments, an electronic device (e.g., the second electronic device 20 of FIG. 2) may include a display (e.g., the display 262 of FIG. 2), a communication circuit (e.g., the communication circuit 292 of FIG. 2), a processor (e.g., the processor 222 of FIG. 2) operatively connected to the display and the communication circuit, and a memory (e.g., the memory 232 of FIG. 2) operatively connected to the processor. For example, the memory may store one or more instructions that, when executed, cause the processor of the electronic device to perform the operations described below.

According to various embodiments, in operation 1505, the processor may receive, from an external server device (e.g., the server 30 of FIG. 2), shared data and meta data generated by the external server device using the communication circuit. For example, the shared data may be shared data transmitted by an external electronic device (e.g., the first electronic device 10 of FIG. 2) to the external server device. For example, the external server device may generate the meta data based on the shared data, and may transmit the shared data and the generated meta data to the electronic device. For example, the meta data may include attribute information and category information about content of the shared data. For example, the shared data may include at least one web page address.

According to various embodiments, in operation 1510, the processor may reconfigure at least a portion of the shared data based on the meta data and a device attribute of the electronic device. For example, the attribute of the electronic device may be based on a use of the electronic device. For example, the processor may reconfigure at least a portion of the shared data corresponding to the device attribute based on the meta data. For example, the processor may reconfigure at least a portion of pieces of web content corresponding to a plurality of web page addresses based on the device attribute.

According to various embodiments, in operation 1515, the processor may display at least a portion of the reconfigured shared data on the display. For example, the processor may display at least a portion of pieces of reconfigured web content on the display.

According to various embodiments, in operation 1520, the processor may identify at least one keyword at least partially based on the meta data and the device attribute of the electronic device. For example, the processor may identify, as the keyword, a content type (e.g., category) indicated by the meta data. For another example, the processor may identify a keyword corresponding to the attribute of the electronic device from the shared data.

According to various embodiments, in operation 1525, the processor may search for additional information associated with the shared data using the keyword. For example, the processor may search for the additional information by performing a web search using the identified keyword.

According to various embodiments, in operation 1530, the processor may display at least a portion of the additional information searched for on the display. For example, the processor may display the additional information together with at least a portion of the reconfigured shared data.

According to an embodiment, the processor may receive query information associated with the shared data from the external server device using the communication circuit, and may further display, on the display, additional information associated with at least a portion of the reconfigured shared data, based on the received query information. For example, the processor may perform a web search using the received query information, and may obtain the additional information based on a result of the web search.

[symbol]

According to various embodiments, a shared data providing method of an electronic device (e.g., the smartphone 302 of FIG. 12) may include: receiving, from an external server device, shared data and meta data generated by the external server device; reconfiguring at least a portion of the shared data based on a device attribute that is set at least partially based on the received meta data and a use of an external electronic device (e.g., the TV 303 of FIG. 12) connected to the electronic device; and displaying at least a portion of the reconfigured shared data on a display of the external electronic device.

According to an embodiment, the shared data providing method may further include: receiving query information associated with the shared data from the external server device; and further displaying, on the display, additional information associated with at least a portion of the reconfigured shared data, based on the received query information.

According to an embodiment, the shared data providing method may further include: performing a web search using the received query information; and obtaining the additional information based on a result of the web search.

According to an embodiment, the reconfiguring of at least a portion of the shared data may include reconfiguring at least a portion of shared data corresponding to a device attribute of the external electronic device based on attribute information and category information about content of the shared data included in the meta data. For example, the shared data may include at least one web page address. According to an embodiment, the reconfiguring of at least a portion of shared data corresponding to the device attribute may include reconfiguring at least a portion of pieces of web content corresponding to the at least one web page address based on the device attribute of the external electronic device.

According to an embodiment, the external electronic device may be a non-portable multimedia viewing device. The reconfiguring of at least a portion of shared data based on the device attribute of the external electronic device may include reconfiguring at least a portion of the shared data including multimedia data, among pieces of the shared data, using the multimedia data.

According to various embodiments, a data sharing system (e.g., the data sharing system 200 of FIG. 2) may include a first electronic device (e.g., the first electronic device 10 of FIG. 10), an external server device (e.g., the server 30 of FIG. 3), and a second electronic device (e.g., the second electronic device 20 of FIG. 3). For example, the first electronic device may be configured to transmit shared data to the external server device (e.g., the server device 30 of FIG. 3). For example, the server may be configured to classify the shared data received from the first electronic device based on a plurality of device attributes, generate meta data including classification information about the shared data, and transmit the meta data and the shared data to the second electronic device (e.g., the second electronic device 20 of FIG. 3) associated with the first electronic device. For example, the second electronic device may be configured to receive the shared data and the meta data from the external server device, reconfigure at least a portion of the shared data based on a device attribute of the second electronic device and the meta data, and provide at least a portion of the reconfigured shared data.

According to an embodiment, the external server device may be further configured to generate query information from content of at least a portion of the shared data based on the device attribute of the second electronic device, and transmit the generated query information to the second electronic device together with the meta data.

According to an embodiment, the second electronic device may be further configured to perform a web search using the received query information, obtain additional information based on a result of the web search, and provide the obtained additional information together with at least a portion of the reconfigured shared data.

According to an embodiment, the shared data may include at least one web page address. The second electronic device may be further configured to reconfigure at least a portion of pieces of web content corresponding to the at least one web page address based on the device attribute of the second electronic device.

According to an embodiment, the external server device may be further configured to transmit the meta data and the shared data to the first electronic device.

[symbol]

1. An electronic device comprising:
a display;
a communication circuit;
a processor operatively connected to the display and the communication circuit; and
a memory operatively connected to the processor,
wherein the memory stores instructions that, when executed, cause the processor to:
receive, from an external server device, shared data and meta data generated by the external server device using the communication circuit;
reconfigure at least a portion of the shared data based on a device attribute that is set at least partially based on the received meta data and a use of the electronic device; and
display at least a portion of the reconfigured shared data on the display.

2. The electronic device of claim 1, wherein the instructions, when executed, cause the processor to:
receive query information associated with the shared data from the external server device using the communication circuit; and
further display, on the display, additional information associated with at least a portion of the reconfigured shared data based on the received query information.

3. The electronic device of claim 2, wherein the instructions, when executed, cause the processor to:
perform a web search using the received query information; and
obtain the additional information based on a result of the web search.

4. The electronic device of claim 1,
wherein the meta data includes attribute information and category information about content of the shared data, and
wherein the instructions, when executed, cause the processor to reconfigure at least a portion of shared data corresponding to the device attribute based on the attribute information and the category information.

5. The electronic device of claim 1, wherein the shared data includes at least one web page address.

6. The electronic device of claim 5, wherein the instructions, when executed, cause the processor to:
reconfigure at least a portion of pieces of web content corresponding to the at least one web page address; and
display, on the display, at least a portion of pieces of the reconfigured web content as at least a portion of the reconfigured shared data.

7. The electronic device of claim 1,
wherein the electronic device is a non-portable multimedia viewing device, and
wherein the instructions, when executed, cause the processor to reconfigure at least a portion of the shared data including multimedia data, among pieces of the shared data, using the multimedia data.

8. The electronic device of claim 1,
wherein the electronic device is a refrigerator, and
wherein the instructions, when executed, cause the processor to reconfigure at least a portion of the shared data including content related to food or cooking, among pieces of the shared data.

9. A shared data providing method of an electronic device, comprising:
receiving, from an external server device, shared data and meta data generated by the external server device;
reconfiguring at least a portion of the shared data based on a device attribute that is set at least partially based on the received meta data and a use of an external electronic device connected to the electronic device; and
displaying at least a portion of the reconfigured shared data on a display of the external electronic device.

10. The method of claim 9, further comprising:
receiving query information associated with the shared data from the external server device; and
further displaying, on the display, additional information associated with at least a portion of the reconfigured shared data, based on the received query information.

11. The method of claim 10, further comprising:
performing a web search using the received query information; and
obtaining the additional information based on a result of the web search.

12. The method of claim 9, wherein the reconfiguring of at least a portion of the shared data includes reconfiguring at least a portion of shared data corresponding to a device attribute of the external electronic device based on attribute information and category information about content of the shared data included in the meta data.

13. The method of claim 9, wherein the shared data includes at least one web page address.

14. The method of claim 13, wherein the reconfiguring of at least a portion of shared data corresponding to the device attribute includes reconfiguring at least a portion of pieces of web content corresponding to the at least one web page address based on the device attribute of the external electronic device.

15. The method of claim 9,
wherein the external electronic device is a non-portable multimedia viewing device, and
wherein the reconfiguring of at least a portion of shared data based on the device attribute of the external electronic device includes reconfiguring at least a portion of the shared data including multimedia data, among pieces of the shared data, using the multimedia data.
